(19) United States
(12) Patent Application Publication
(10) Pub. No.: US 2008/0016157 A1
(43) Pub. Date: Jan. 17, 2008

(54) METHOD AND SYSTEM FOR CONTROLLING AND MONITORING AN APPARATUS FROM A REMOTE COMPUTER USING SESSION INITIATION PROTOCOL (SIP)

(75) Inventors: Kurosh Mohammad SAHRAIE, North Vancouver (CA); Hassan FIROUZBAKHT, West Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: CENTRALTOUCH TECHNOLOGY INC., North Vancouver (CA)

(21) Appl. No.: 11/770,460

(22) Filed: Jun. 28, 2007

Related U.S. Application Data
(60) Provisional application No. 60/806,190, filed on Jun. 29, 2006.

(51) Int. Cl. G06F 15/16

(52) U.S. Cl. 709/205; 709/206

(57) ABSTRACT

A system for using Session Initiation Protocol for network element monitoring can issue network monitoring commands to embedded agents over a number of different network topologies. The embedded agents are SIP aware and can be designed for a number of different platforms allowing thin client systems to perform the required actions to respond to the SIP monitoring request and to create a SIP response. This system can be used to monitor any of a number of networked elements, and their associated peripherals, operating systems, applications, file systems, or hardware components.

### CROSS-REFERENCE TO RELATED APPLICATION

This application claims the benefit under 35 U.S.C. section 119 of U.S. application No. 60/806,190 filed on 29 Jun. 2006 and entitled METHOD AND SYSTEM FOR CONTROLLING AND MONITORING AN APPARATUS FROM A REMOTE COMPUTER USING SESSION INITIATION PROTOCOL (SIP), which is hereby incorporated herein by reference in its entirety.

### FIELD OF THE INVENTION

This invention relates generally to remote monitoring and control of networked equipment such as personal computers and servers. More particularly, the present invention relates to the use of Session Initiation Protocol signaling in a networked monitoring and control system.

### BACKGROUND OF THE INVENTION

Event notification in computer networks is used to provide network administrators and other individuals with information about remote computers or network equipment. Typically, monitoring of networked elements has required network elements being monitored to run a monitoring agent.

In some prior art systems, monitored elements received messages at fixed intervals requesting updates, while in other systems, the monitored elements prepare and send updates either at fixed intervals or after key events (e.g. user login). One known problem with such systems is that the monitoring node and the monitored node required the ability to see each other in the network topology (have IP access to each other). If the monitoring node was part of a network that had a firewall or gateway that made use of technologies such as Network Address Translation (NAT), and the monitored node was a part of another similar network, it became difficult for the nodes to communicate with each other. To facilitate such communication the network gateways or firewalls had to make exceptions for requests on defined ports. This opened the network to attacks.

Some systems obviated this problem by making use of email as a delivery mechanism for the request and response. A server could issue an email message containing executable code that would inventory the system and then issue a response. Although this technique can be successful in bypassing obstacles posed by NAT and other such techniques, it requires that the monitored node be associated with a user account that will respond to email messages, and also requires that the user account allow email messages to be automatically executed, which is a security hole that many network administrators are loathe to allow to remain open.

It would be desirable to provide a network monitoring and control system that could traverse different network topologies and does not rely upon user interaction so that a greater number of network elements can be monitored and controlled remotely without compromising security.

### SUMMARY OF THE INVENTION

It is an object of the present invention to obviate or mitigate at least one disadvantage of previous network event notification and control systems.

In a first aspect of the present invention, there is provided a method performed by a SIP (Session Initiation Protocol) User Agent installed in a computer to allow monitoring, controlling, and data retrieval from another SIP User Agent installed on another apparatus by sending and receiving formatted text messages as part of one or several SIP Messages or Subscription/Notification messages. The method comprises the steps of preparing an instructional message which is embedded as part of a SIP message; sending the instructional message to another SIP User Agent installed on another apparatus; receiving, extracting, parsing, and interpreting the instructional message by a SIP User Agent installed on an apparatus; gathering data related to the apparatus, and sending the data as part of a SIP message to another SIP User Agent for further processing; performing action on the apparatus based on received instructions as part of a SIP message; informing another SIP User Agent about the results of an action performed on an apparatus initiated by a SIP User Agent, in which case the information is embedded as part of a SIP message; and preparing and sending notification information embedded as part of a SIP message related to an event triggered on an apparatus and detected by a SIP User Agent installed on the apparatus. In an embodiment of the first aspect of the present invention, the formatted SIP message includes eXtensible Markup Language (XML) data, and the transmitted data is included as part of an SDP (Session Description Protocol) section of the SIP message.

In a second aspect of the present invention, there is provided a method performed by a SIP User Agent installed on an apparatus to monitor and report information on the state of the apparatus, attached peripherals, sensors, software applications, services, operating system, and/or file system (“remote entity”) to a remote computer (“controller”) via SIP Protocol. The method comprises the steps of detecting the state of the apparatus, wherein detecting is performed by monitoring variables associated with the apparatus, the monitoring occurring independently of communications with the remote computer; detecting the state of the peripherals or sensors attached to the apparatus, wherein detecting is performed by monitoring variables associated with the peripherals or sensors, the monitoring occurring independently of communications with the remote computer; detecting the state of any application, service, or executable software, wherein detecting is performed by monitoring the process state, application state, file system, log system, or through any software specific programming interface; the monitoring occurring independently of communications with the remote computer; and generating a SIP message that reports the information or state of the apparatus, peripherals, sensors, executable software, services, operating system, or file system using a formatted text message as part of the SIP message, wherein generating is performed periodically, in response to a request message from the controller, or in response to a deviation in the state; and sending the message to the remote computer using the SIP protocol.

In embodiments of the second aspect of the present invention, gathering of the data or detecting the state comprises receiving the variables from the apparatus, the apparatus's operating system, the apparatus's file system, the apparatus's attached sensors, or a software application executed on the apparatus. In another embodiment, the message comprises a formatted SIP message carried to a remote computer as part of a SIP message containing eXtensible Markup Language (XML) data. In further embodiments, the information or state of the apparatus is included as part of an SDP (Session Description Protocol) section of the SIP message. In embodiments, the information or state is included as part of an attribute of the message. The SIP message may include past information or state data and the SIP message can include a unique identifier that corresponds to the apparatus.

In a third aspect of the present invention, there is provided a method, performed by a computer, for requesting and obtaining a state of an apparatus, attached peripheral, software application, service, or file system from an apparatus. The method comprises the steps of sending a text formatted control message as part of a SIP message from one SIP User Agent installed on one computer to a second SIP User Agent installed on a second apparatus in order to request information about the second apparatus's operating system, software, hardware, attached peripherals, sensors, services, or file system; and receiving a message from the SIP User Agent that reports the state information of the apparatus, attached peripheral, software application, service, or file system using a formatted message as part of one or several SIP Messages, the message being received periodically, in response to a formatted request message, or in response to a deviation in the state.

The message can include XML data. The method may further comprise the step of passing the requested information to an issue tracking system, such as but not limited to, a customer relationship management, or support system. In another embodiment, a SIP User Agent is embedded in the apparatus. In a further embodiment, the computer or software application sends a formatted text message to request specific data including information on the state of an apparatus, attached peripheral, sensor, software application, service, or file system as part of one or several SIP messages. In another embodiment, the computer or software application sends a formatted text message to request specific data including information on the state of an apparatus, attached peripheral, sensor, software application, service, or file system as part SDP section of one or several SIP messages.

In a fourth aspect of the present invention, there is provided a method, performed by a computer, for sending action instructions to a SIP User Agent installed on an apparatus. The SIP User Agent may receive the instruction as part of a SIP message, interpret the instruction, and then perform actions based on the content of the SIP Message. The method comprises the steps of sending a formatted SIP Message containing specific instructions to be executed on the apparatus by a SIP User Agent immediately, at an instructed time, or at an instructed recurring interval for a specified duration; receiving a formatted SIP Message containing specific instructions to be executed by a SIP User Agent; further executing actions based on instructions received as part of a SIP Message; and further executing actions based on instructions received as part of a SIP Message and then replying to the SIP Message by a new SIP Message containing the information related to the results of the execution of instructions to the first computer's SIP User Agent. In embodiments of this aspect of the present invention, the message includes eXtensible Markup Language (XML) data, and can be embedded as part of the SDP section of the SIP Message.

In a fifth aspect of the present invention, there is provided a method, performed by a SIP User Agent, installed in an apparatus, for sending information to another SIP User Agent as part of a SIP Message to inform the second SIP User Agent about any changes in state of the apparatus, any change of state in the attached peripheral to the apparatus, any change of state in the sensors attached to the apparatus, any change of status in the apparatus's operating system, any change of state in any software application installed on the apparatus, any change of state in the services of the apparatus, and/or any change of state in the file system of the apparatus. In embodiments of this aspect of the present invention, the message includes eXtensible Markup Language (XML) data, and can be embedded as part of the SDP section of the SIP Message.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures.

FIG. 1 Illustrates high level connectivity requirements and some examples of different apparatus which may be controlled or monitored by intelligent SIP User Agents and utilization of SIP Protocol over any existing wired or wireless communication path. Essentially, any SIP-enabled (A device that can host a SIP User Agent Software) device can be considered as a potential end-point. These include, but are not limited to: Personal Computers, Networked Printers, Voice Over IP (VoIP) equipment, VoIP Phones, WiFi equipment, Networked equipment, etc.

FIG. 2 Illustrates a simple Monitoring and Notification Process between two SIP User Agents utilizing SIP and SIMPLE (SIP for Instant Messaging and Presence Leveraging Extensions) protocols. For example, a SIP User Agent may subscribe to receive notification events from another SIP User Agent (Remote Device) when a new Event Log Entry is created by any application on the Remote Device.

FIG. 3 Illustrates a simple Data Enquiry Process between two SIP User Agents utilizing SIP and SIMPLE (SIP for Instant Messaging and Presence Leveraging Extensions) protocols.

FIG. 4 Illustrates a simple Remote Control Process between 2 SIP User Agents utilizing SIP and SIMPLE (SIP for Instant Messaging and Presence Leveraging Extensions) protocols. An example of such instructional message is to execute a command on the remote device.

FIG. 5 illustrates apparatus according to an example embodiment of the invention in which a SIP user agent at a server controller generates SIP messages containing instructions. A SIP user agent at an apparatus receives the SIP messages from the server or controller and generates a SIP message containing information related to the apparatus. In the illustrated embodiment, the information comprises variables, notification information and an apparatus identifier. The information may optionally be passed to a system that uses the information such as a tracking or CRM system, a database, or the like.

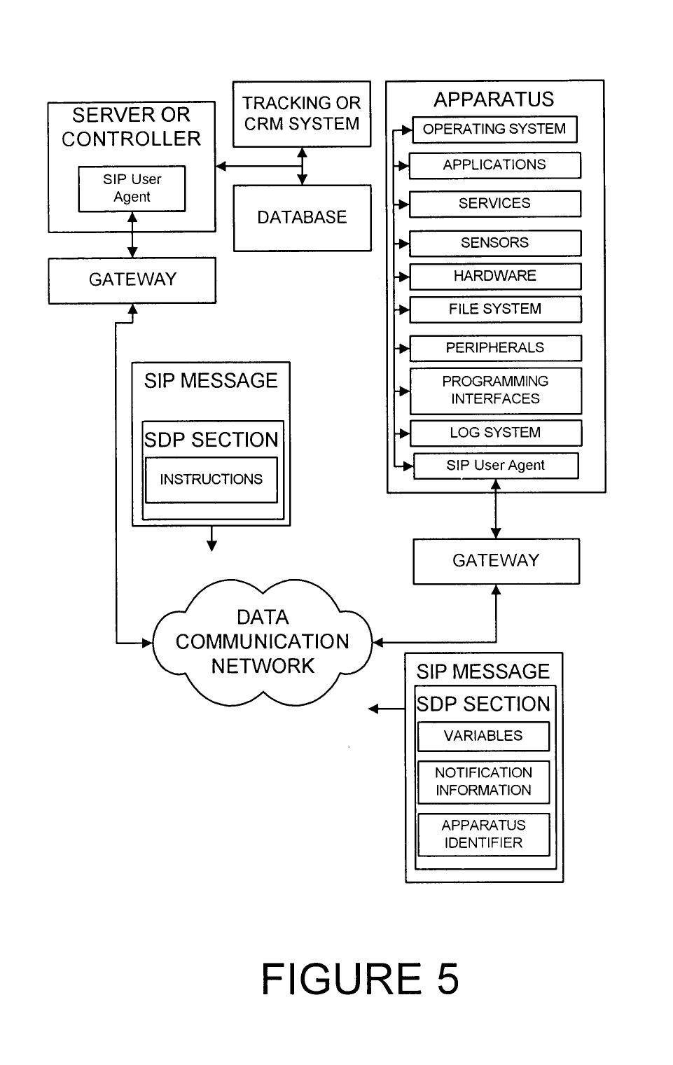

### DETAILED DESCRIPTION

Generally, the present invention provides a method and system for computer network event monitoring and remote control.

In the following description, for purposes of explanation, numerous details are set forth in order to provide a thorough understanding of the present invention. However, it will be apparent to one skilled in the art that these specific details are not required in order to practice the present invention. For example, specific details are not provided as to whether the embodiments of the invention described herein are implemented as a software routine, hardware circuit, firmware, or a combination thereof. SIP agents can be created as distinct elements in a physical entity, or can be implemented as software executed by a processor in the physical entity that is used for general purpose processing. Thus, SIP agents, and other described agent related elements can be implemented either as dedicated elements, as logically distinct elements executed on a processor, or as part of a more complex software application.

Session Initiation Protocol (SIP) was developed to provide a mechanism for initiating, modifying, and terminating an interactive user session that involves multimedia elements. It has since become a key element in Voice over Internet Protocol connections as a signaling protocol used in the establishment of data connections.

Network elements running SIP can function in a peer-to-peer configuration or can make use of a centralized directory to provide centralized access and functionality. SIP can also typically function across Network Address Translation (NAT) proxies allowing access from one protected network to another.

SIP agents can be designed for low processing power systems, such as VoIP handsets, and thus can be created using any number of programming languages on any of a number of different platforms.

The present invention makes use of SIP for network element monitoring and remote control. The use of SIP allows NAT gateways to be traversed, and allows for simple configuration of monitored elements. Furthermore, a SIP agent can be created for a network element that will be monitored or controlled. Such a SIP Agent may be referred to as an Embedded Agent. The use of SIP to communicate to the Embedded Agent, allows thin clients lacking processing power to be monitored and controlled. Thus, instead of being limited by either network topology or by the ability to respond to processor-intensive agents (such as an email system) the present invention provides a system and method to enable a variety of different platforms, over a variety of different network topologies to be monitored and controlled. Furthermore, the request for an updated status can also include instructions to send the response to another SIP agent, thus a single central network element can issue a monitoring request, and have different sets of elements send their replies to a plurality of secondary SIP Agents on different servers. This allows for distribution of the workload of receiving the responses. The SIP request can also instruct network elements to report on the status of peripherals, hardware, or software elements on, or attached to the hosting device that are otherwise inaccessible to the monitoring SIP Agents' system.

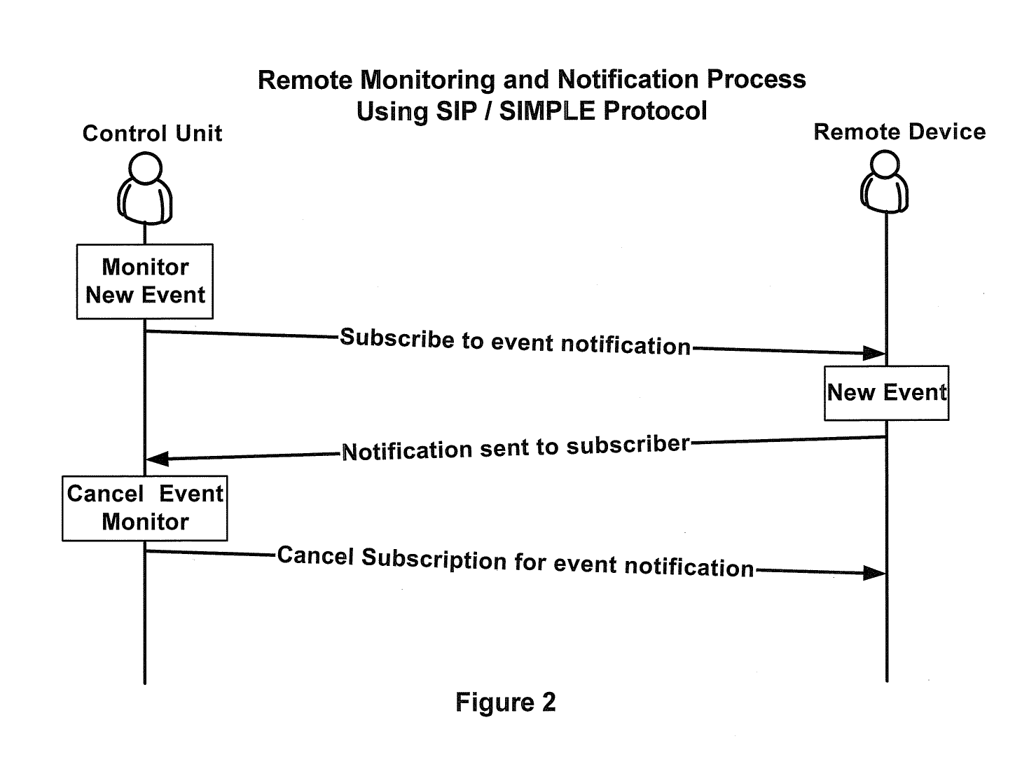

A SIP User Agent can be used to subscribe to an event notification from one computer to another SIP user agent embedded in an apparatus. The subscription can be embedded as formatted text as part of a SIP Message or SDP section of a SIP Message. (see FIG. 2).

A SIP User Agent embedded in an apparatus (an “embedded user agent”) can then be used to report the state of the apparatus, attached peripherals, attached sensors, software applications, services, operating system, system's registry, system's event log, and/or file system of the apparatus to a remote computer based on received subscription messages (see FIG. 2). This allows for monitoring of peripherals that may not necessarily be accessible to a monitoring server, and allows a distribution of the monitoring work load.

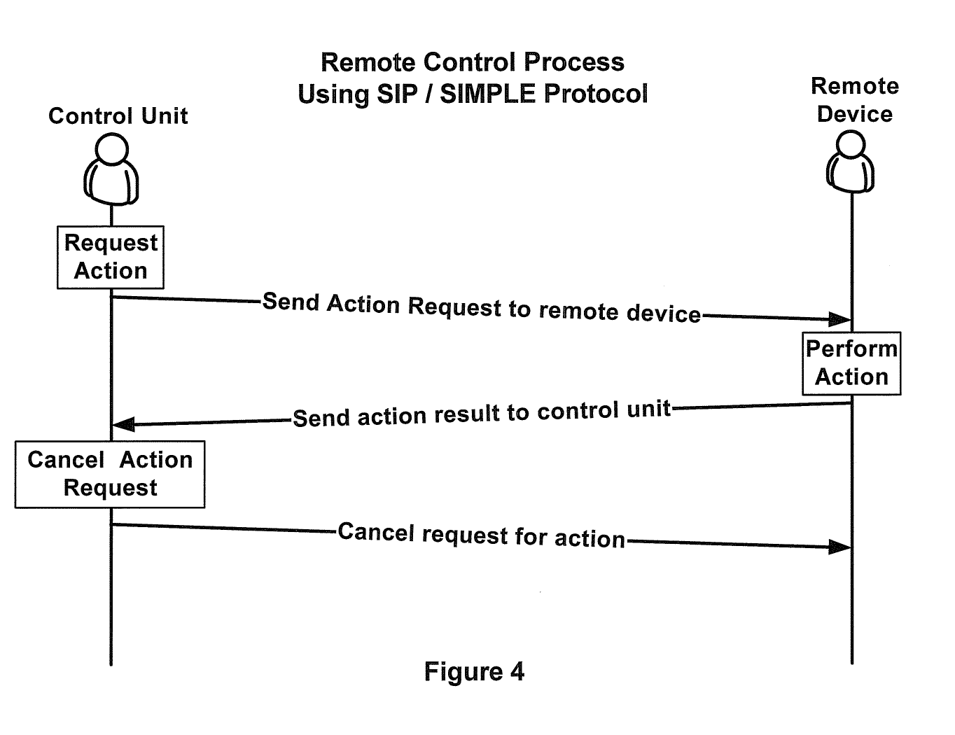

A SIP User Agent at a server can be used to send action instructions from one computer to another SIP user agent embedded in an apparatus. The instruction can be embedded as formatted text as part of a SIP Message or SDP section of a SIP Message (see FIG. 4). This allows the monitoring server to issue instructions to monitored devices over numerous different network topologies.

A SIP User Agent embedded in an apparatus (an “embedded user agent”) can be used to receive action instructions in numerous formats such as formatted text which is part of a SIP Message. The embedded user agent can then interpret the instructions, perform a specific action related to the instructions and send a formatted SIP message to the source of the instructions. The formatted SIP message to the instruction source will typically include the results of the action (see FIG. 4).

Upon receiving one or more SIP Message requests, an embedded user agent in an apparatus can create a SIP message response that includes state information or data related to the apparatus, its peripherals, attached sensors, operating system, system's registry, system's event log, software applications, services, and/or file system. This SIP message response can then be sent back to the node initiating the SIP message requests, which may, for example, be a system such as a customer relationship management system (CRM), issue tracking system, or contact management system. Upon receipt of the SIP message response, the node initiating the SIP message requests can store the information in file system or a database, or propagate the message to another application for further processing.

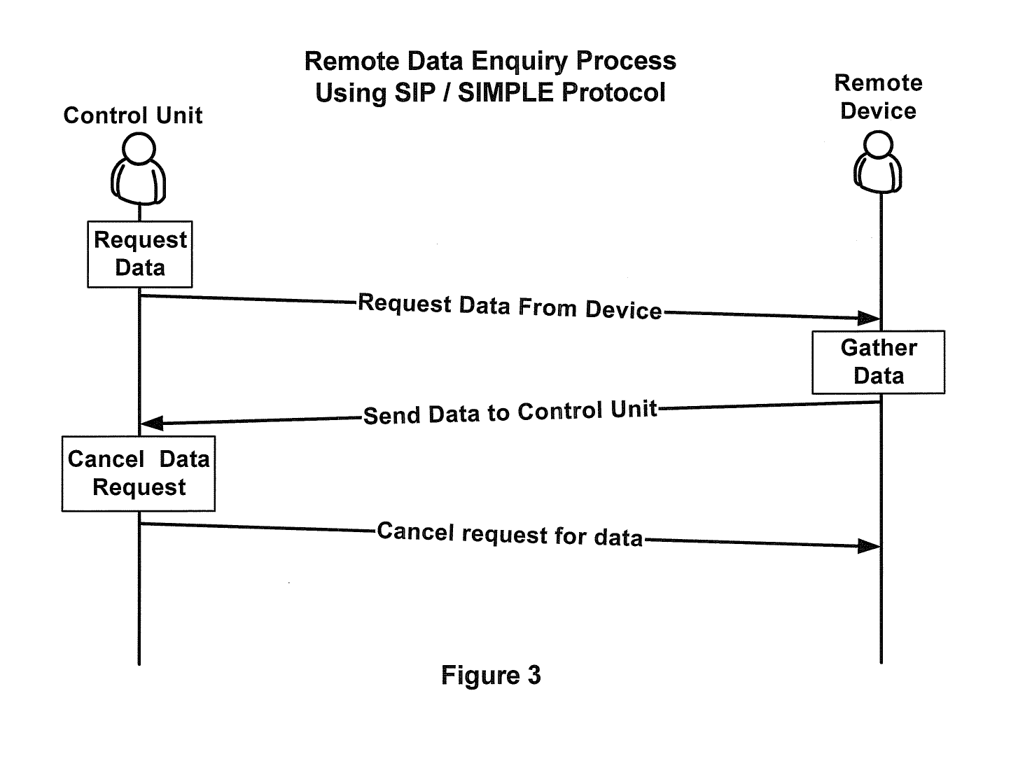

The SIP User Agent can be used to send information enquiry instructions (“data enquiry”) from one computer to a SIP user agent embedded in an apparatus. The data enquiry can be embedded as formatted text as part of a SIP Message or SDP section of a SIP Message (see FIG. 3).

A SIP User Agent embedded in an apparatus (an “embedded user agent”) can be used to receive data enquiry instructions as formatted text in a SIP Message, interpret the instructions, gather data related to the instructions and send a formatted SIP message to the source of enquiry which will include the requested data in response (see FIG. 3).

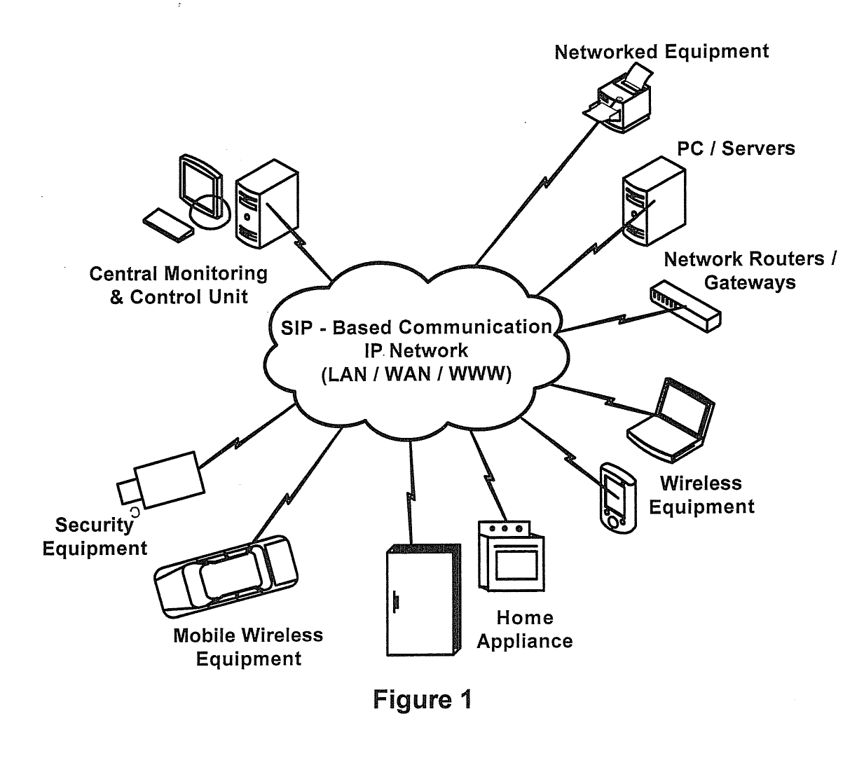

An apparatus may contain an embedded SIP User Agent (“embedded user agent”), to monitor and control its operation. Any type of apparatus may have an embedded device containing a SIP User Agent, including, but not limited to, home appliances, such as washing machines, dishwashers, and televisions, and manufacturing equipment, such as robotics, conveyors and motors (see FIG. 1).

Embedded user agents are often connected to an internal network, such as a local area network (LAN), with an interface to the Internet. Other devices on the internal network may communicate with the embedded user agent over the internal network through other specific network protocols such as TCP, UDP, SMTP, HTTP, HTTPS, TLS, SNMP, or SIP.

In general, in one aspect, the invention is directed to using a SIP User Agent embedded in an apparatus to intercept an instructional message to perform actions, gather and return informational data, or monitor and report the state of the apparatus, its peripherals, attached sensors, software applications, services, operating system, and/or file system to a remote computer. This aspect of the invention features: subscribing to a specific event notification, detecting the state change(s), generating a SIP message that reports the state change(s) using a formatted text, and sending the SIP message to the remote computer (“the subscriber”). An example of a format for the formatted text message is eXtensible Markup Language (XML).

By using a SIP Message to carry the information, the remote computer can obtain the state of the apparatus even if the remote computer cannot directly address the embedded user agent. Thus, computers that cannot communicate directly with the embedded user agent, such as computers that are not on the same internal network as the embedded user agent, can still obtain the status of the apparatus. Moreover, because the state is reported using a formatted text message, the remote computer can interpret the state information without the aid of a person. As a result, processes, such as monitoring, maintenance and control can be automated for the apparatus by the remote computer.

Another aspect of the invention is directed to using a SIP User Agent to prepare and send instructional messages as formatted text messages embedded as part of SIP Messages or as part of the SDP section of a SIP Message. The instructional message may carry self-describing definitions for specific instructions that the embedded user agent may interpret and map to one or more actions to be performed on the remote apparatus.

The invention may include one or more of the following features.
An instructional message formatted as XML content, embedded as part of a SIP Message and sent from a SIP User agent (“controller”) to an embedded user agent installed on a remote apparatus (“embedded user agent”).
The instruction may be related to an action, or list of actions, that are requested to be performed on the remote apparatus immediately, or at a certain time, or based on a deviation in state, or at a recurring interval, by the embedded user agent.
The embedded user agent can receive the SIP Message, interpret the embedded instructional content, and decide which action(s) should be performed and when to execute them. The embedded user agent may also invoke other applications on the hosting device in order to further process the message and perform necessary actions.
The embedded user agent can perform the requested action, or list of actions, and then may prepare a result message that informs the sender of the instruction (“controller”), or another SIP User agent, about the result of the action(s) performed on the apparatus with relation to the received instruction(s).
The controller user agent may receive the SIP Message from the embedded user agent, interpret the content, extract the result, and decide to propagate the result to an external CRM, Contact Management, or Issue Tracking System, or record the result in a defined storage system such as file or database. The controller user agent may also decide, based on defined rules and conditions, to relay the message to another controller or prepare a new SIP Message with relevant information and send it to another user agent for further processing.
An instruction message from the controller user agent to an embedded user agent may also result in no immediate response from the embedded user agent in the apparatus. In this case, the message may include commands such as monitoring instructions which may or may not result in any response messages until the monitoring criteria is fulfilled on the apparatus.

Once the monitoring criteria is fulfilled on the apparatus, depending on the monitoring parameters, the embedded user agent will prepare and send a formatted text message as part of a SIP Message or SDP section of a SIP Message, which will have proper information about the triggering event, to the controller user agent.

A system for using Session Initiation Protocol for network element monitoring can issue network monitoring commands to embedded agents over a number of different network topologies. The embedded agents are SIP-aware and can be designed for a number of different platforms allowing thin client systems to perform the required actions to respond to SIP monitoring requests and to create SIP responses. This system can be used to monitor any of a number of networked elements, and their associated peripherals.

Embodiments of the invention may be represented as a software product stored in a machine-readable medium (also referred to as a computer-readable medium, a processor-readable medium, or a computer-usable medium having a computer readable program code embodied therein). The machine-readable medium may be any suitable tangible medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, causes a processor to perform steps in a method according to an embodiment of the invention. Those of ordinary skill in the art will appreciate that other instructions and operations necessary to implement the described invention may also be stored on the machine-readable medium. Software running from the machine readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method performed by a SIP (Session Initiation Protocol) User Agent installed in a computer to allow monitoring, controlling, and data retrieval from another SIP User Agent installed on another apparatus by sending and receiving formatted text messages as part of one or several SIP Messages or Subscription/Notification messages, the method comprising:
preparing an instructional message which is embedded as part of a SIP message;
sending the instructional message to another SIP User Agent installed on another apparatus;
receiving, extracting, parsing, and interpreting the instructional message by a SIP User Agent installed on an apparatus; and,
performing one or more of:
gathering data related to the apparatus, and sending the data as part of a SIP message to another SIP User Agent for further processing;
performing action on the apparatus based on instructions received as part of a SIP message;
informing another SIP User Agent about the results of an action performed on an apparatus initiated by a SIP User Agent, in which case the information is embedded as part of a SIP message; and
preparing and sending notification information embedded as part of a SIP message related to an event triggered on an apparatus and detected by a SIP User Agent installed on the apparatus.

2. The method of claim 1, wherein the formatted SIP message comprises eXtensible Markup Language (XML).

3. The method of claim 1, wherein the transmitted data is included as part of an SDP (Session Description Protocol) section of the SIP message.

4. A method performed by a SIP User Agent installed on an apparatus to monitor and report information on one or more of: the state of the apparatus, attached peripherals, sensors, software applications, services, operating system, and file system (“remote entity”) to a remote computer (“controller”) via SIP Protocol, the method comprising:
performing one or more of:
detecting the state of the apparatus, wherein detecting comprises monitoring variables associated with the apparatus, the monitoring occurring independently of communications with the remote computer;
detecting the state of the peripherals or sensors attached to the apparatus, wherein detecting comprises monitoring variables associated with the peripherals or sensors, the monitoring occurring independently of communications with the remote computer; and,
detecting the state of any application, service, or executable software, wherein detecting comprises monitoring the process state, application state, file system, log system, or through any software specific programming interface, the monitoring occurring independently of communications with the remote computer; and
generating a SIP message that reports the information or state of the apparatus, peripherals, sensors, executable software, services, operating system, or file system using a formatted text message as part of the SIP message, wherein generating is performed periodically, in response to a request message from the controller, or in response to a deviation in the state; and sending the message to the remote computer using the SIP protocol.

5. The method of claim 4, wherein gathering of the data or detecting the state comprises receiving the variables from the apparatus.

6. The method of claim 4, wherein gathering the information or detecting the state comprises receiving the variables from an operating system of the apparatus.

7. The method of claim 4, wherein gathering the information or detecting the state comprises receiving the variables from a file system of the apparatus.

8. The method of claim 4, wherein gathering the information or detecting the state comprises receiving the variables from one or more sensors attached to the apparatus.

9. The method of claim 4, wherein gathering the information or detecting the state comprises receiving the variables from a software application executed on the apparatus.

10. The method of claim 4, wherein the message comprises a formatted SIP message.

11. The method of claim 4, wherein the message is carried to a remote computer as part of a SIP message.

12. The method of claim 4, wherein the formatted SIP message comprises eXtensible Markup Language (XML).

13. The method of claim 4, wherein the information or state of the apparatus is included as part of an SDP (Session Description Protocol) section of the SIP message.

14. The method of claim 4, wherein the information or state is included as part of an attribute of the message.

15. The method of claim 4, wherein the SIP message includes past information or state data.

16. The method of claim 4, wherein the SIP message includes a unique identifier that corresponds to the apparatus.

17. A method, performed by a computer, for requesting and obtaining a state of one or more of: an apparatus, attached peripheral, software application, service, or file system from an apparatus, the method comprising:
sending a text formatted control message as part of a SIP message from one SIP User Agent installed on one computer to a second SIP User Agent installed on a second apparatus in order to request information about one or more of the second apparatus's operating system, software, hardware, attached peripherals, sensors, services, or file system; and
receiving a message from the SIP User Agent that reports the state information of the apparatus, attached peripheral, software application, service, or file system using a formatted message as part of one or several SIP Messages, the message being received periodically, in response to a formatted request message, or in response to a deviation in the state.

18. The method of claim 17, wherein the message comprises eXtensible Markup Language (XML).

19. The method of claim 17, further comprising passing the requested information to an issue tracking system.

20. The method of claim 17, wherein the SIP User Agent is embedded in the apparatus.

21. The method of claim 17, wherein the computer or software application sends a formatted text message to request specific data including information on the state of an apparatus, attached peripheral, sensor, software application, service, or file system as part of one or several SIP messages.

22. The method of claim 17, wherein the computer or software application sends a formatted text message to request specific data including information on the state of an apparatus, attached peripheral, sensor, software application, service, or file system as part SDP section of one or several SIP messages.

23. A method, performed by a computer, for sending action instructions to a SIP User Agent installed on an apparatus wherein the SIP User Agent receives the action instructions as part of a SIP message, interprets the action instructions, and then perform actions based on the content of the SIP Message, wherein the method comprises:
sending a formatted SIP Message containing specific instructions to be executed on the apparatus by a SIP User Agent immediately, at an instructed time, based on a deviation in the state, or at an instructed recurring interval for a specified duration;
receiving the formatted SIP Message containing specific instructions to be executed by the SIP User Agent;
further executing actions based on instructions received as part of a SIP Message; and
further executing actions based on instructions received as part of a SIP Message and then replying to the SIP Message by a new SIP Message containing the information related to the results of the execution of instructions to the first computer's SIP User Agent.

24. The method of claim 23, wherein the message comprises eXtensible Markup Language (XML).

25. The method of claim 23, wherein the message is embedded as part of the SDP section of the SIP Message.

26. A method, performed by a SIP User Agent, installed in an apparatus, for sending information to another SIP User Agent as part of a SIP Message to inform the second SIP User Agent about any changes in state of the apparatus, any change of state in the attached peripheral to the apparatus, any change of state in the sensors attached to the apparatus, any change of status in the apparatus's operating system, any change of state in any software application installed on the apparatus, any change of state in the services of the apparatus, any change of state in the file system of the apparatus.

27. The method of claim 26, wherein the message comprises eXtensible Markup Language (XML).

28. The method of claim 26, wherein the message is embedded as part of the SDP section of the SIP Message.

29. The method of claim 26, wherein the status or state information embedded in the message can be interpreted as an alert or notification by the receiving SIP User Agent.

30. The method of claim 26, wherein the status or state information embedded in the message can be further propagated to a trouble tracking system, customer relation management system, or storage system such as file, or database by the receiving SIP User Agent.
